(19) United States
(12) Patent Application Publication
(10) Pub. No.: US 2009/0274099 A1
(43) Pub. Date: Nov. 5, 2009

(54) METHODS AND APPARATUS FOR COMMUNICATING TRANSMITTER INFORMATION IN A COMMUNICATION NETWORK

(75) Inventors: Qiang Gao, San Diego, CA (US); An Mei Chen, San Diego, CA (US); Ashok Mantravadi, San Diego, CA (US); Krishna Kiran Mukkavilli, San Diego, CA (US); Murali Ramaswamy Chari, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/433,845

(22) Filed: Apr. 30, 2009

Related U.S. Application Data
(60) Provisional application No. 61/050,098, filed on May 2, 2008.

(51) Int. Cl. H04W 8/00

(52) U.S. Cl. 370/328

(57) ABSTRACT

Methods and apparatus for communicating transmitter information in a communication network are disclosed. The methods and apparatus communicate transmitter specific information, in particular, which includes location information about network transmitters for use in location or positioning type services. The disclosed methods and apparatus include inserting such transmitter specific information within either a data flow of at least one transmission frame or a control channel in the at least one transmission frame. In addition, a transmitter identifier is encoded in a positioning pilot channel (PPC) within the at least one transmission frame, and the configured transmission frame transmitted to a user device. The user device may use the transmitter specific information of numerous transmitters along with the transmitter identifiers to measure how far it is from the transmitters, and then triangulate to determine position.

### CLAIM OF PRIORITY UNDER 35 U.S.C. §119

The present Application for Patent claims priority to Provisional Application No. 61/050,098 entitled “Methods and Apparatus for Positioning Service in a Broadcast Network” filed May 2, 2008, and assigned to the assignee hereof and hereby expressly incorporated by reference herein.

### REFERENCE TO CO-PENDING APPLICATIONS FOR PATENT

The present Application for Patent is related to the following co-pending U.S. Patent Applications:

“Enhancements to the Positioning Pilot Channel” by Mukkavilli et al., having U.S. Ser. No. 12/165,653, filed Jul. 1, 2008, assigned to the assignee hereof, and expressly incorporated by reference herein.

“Methods and Apparatus for Transmitter Identification in a Wireless Network” by Mukkavilli et al., having U.S. Ser. No. 11/834,654, filed Aug. 6, 2007, assigned to the assignee hereof, and expressly incorporated by reference herein.

“Methods and Apparatus for Position Location in a Wireless Network” by Mukkavilli et al., having U.S. Ser. No. 11/517,119, filed Sep. 6, 2006, assigned to the assignee hereof, and expressly incorporated by reference herein.

### BACKGROUND

1. Field

The present application generally relates to the operation of communication systems, and more particularly, to methods and apparatus for communicating transmitter specific information including transmitter location information used for positioning services in a broadcast communication system.

2. Background

In certain communication systems, such as content delivery/media distribution systems (e.g., Forward Link Only (FLO) or Digital Video Broadcast (e.g., DVB-H) systems), real time and non-real time services are typically packed into transmission frames (e.g., a FLO superframe) and delivered to devices on a network. Additionally, such communication systems may utilize Orthogonal Frequency Division Multiplexing (OFDM) to provide communications between a network server and one or more mobile devices. This communication provides a transmission superframe having data slots that are packed with content to be delivered over a distribution network as a transmit waveform.

It is known in particular systems, such as FLO systems, to provide transmitter identification information enabling mobile devices to determine position. The mechanism to effect positioning in FLO networks, for example, involves configuring each transmitter in a broadcast network to transmit respective information specific to that transmitter, such as a transmitter identification (ID) and transmitter location, as examples. A mobile device may use the transmitter specific information from a number of transmitters, along with measured propagation delays of the signals carrying the information from the identified transmitters to determine its position using a triangulation method.

In broadcast systems, such as MediaFLO, a dedicated Positioning Pilot Channel (PPC) can be used to transmit the transmitter ID and other transmitter specific information such as transmitter location to afford mobile users positioning service. In some cases, however, one concern with the use of the PPC to communicate transmitter specific information, such as location information, is that this may present compromised security due to the lack of sufficient encryption available in the PPC channel. In addition, the PPC channel also has limited bandwidth, which may restrict the extent and frequency of transmitter specific information sent on the PPC channel. Thus, there is a need to be able to communicate at least a portion of the transmitter specific information through other means within a superframe to system devices.

### SUMMARY

According to an aspect of the present disclosure, a method for communicating transmitter specific information in a broadcast communication system is taught. The method includes inserting transmitter specific information within one of a data flow in at least one transmission frame and a control channel of the at least one transmission frame, wherein the transmitter specific information includes location information about at least one transmitter. The method further includes encoding a transmitter identifier in a positioning pilot channel (PPC) within the at least one transmission frame, and then transmitting the at least one transmission frame to at least one user device.

In another disclosed aspect, an apparatus for communicating transmitter specific information in a broadcast communication system is taught. The apparatus includes at least one processing unit configured to insert transmitter specific information within one of a data flow in at least one transmission frame and a control channel of the at least one transmission frame, wherein the transmitter specific information includes location information about at least one transmitter. The at least one processing unit is also configured to encode a transmitter identifier in a positioning pilot channel (PPC) within the at least one transmission frame, and transmit the at least one transmission frame to at least one user device. The apparatus also includes a memory coupled to the at least one processing unit.

In yet another aspect, an apparatus for communicating transmitter specific information in a broadcast communication system is disclosed. The apparatus has means for inserting transmitter specific information within one of a data flow in at least one transmission frame and a control channel of the at least one transmission frame, wherein the transmitter specific information includes location information about at least one transmitter. The apparatus further includes means for encoding a transmitter identifier in a positioning pilot channel (PPC) within the at least one transmission frame, and means for transmitting the at least one transmission frame to at least one user device.

In still another aspect, a computer-readable medium is disclosed, where the medium includes code for causing a processing unit to insert transmitter specific information within one of a data flow in at least one transmission frame and a control channel of the at least one transmission frame, wherein the transmitter specific information includes location information about at least one transmitter. The medium also includes code for causing a processing unit to encode a transmitter identifier in a positioning pilot channel (PPC) within the at least one transmission frame. Additionally, the medium includes code for causing a processing unit to initiate transmission of the at least one transmission frame to at least one user device.

In a further aspect, a method for receiving transmitter identification information in a device in a communication system is disclosed. The method includes receiving at least one transmission frame from a transmitter, wherein the transmission frame includes transmitter specific information placed within one of a data flow in the at least one transmission frame and a control channel of the at least one transmission frame, wherein the transmitter specific information includes location information about at least one transmitter. Additionally, the method includes receiving the at least one transmission frame and at least one other of a plurality of transmission frames, each including a PPC channel having a respective encoded transmitter identifier. Finally, the method includes decoding the at least one transmission frame and the at least one other of the plurality of transmission frames to determine the transmitter specific information from one of the data flow and the control channel, and to determine transmitter identifiers from the respective PPC channels.

In still a further aspect, an apparatus for receiving transmitter specific information in a broadcast communication system is disclosed. The apparatus includes at least one processing unit configured to receive at least one transmission frame from a transmitter, wherein the transmission frame includes transmitter specific information placed within one of a data flow in the at least one transmission frame and a control channel of the at least one transmission frame, wherein the transmitter specific information includes location information about at least one transmitter. The at least one processing unit is also configured to receive the at least one transmission frame and at least one other of a plurality of transmission frames, each including a PPC channel having a respective encoded transmitter identifier. Further, the at least one processing unit is configured to decode the at least one transmission frame and the at least one other of the plurality of transmission frames to determine the transmitter specific information from one of the data flow and the control channel, and to determine transmitter identifiers from the respective PPC channels. The apparatus includes a memory coupled to the at least one processing unit.

According to yet a further aspect, an apparatus for receiving transmitter identification information in a device in a communication system is taught. The apparatus includes means for receiving at least one transmission frame from a transmitter, wherein the transmission frame includes transmitter specific information placed within one of a data flow in the at least one transmission frame and a control channel of the at least one transmission frame, wherein the transmitter specific information includes location information about at least one transmitter. The apparatus also includes means for receiving the at least one transmission frame and at least one other of a plurality of transmission frames, each including a PPC channel having a respective encoded transmitter identifier. The apparatus further includes means for decoding the at least one transmission frame and the at least one other of the plurality of transmission frames to determine the transmitter specific information from one of the data flow and the control channel, and to determine transmitter identifiers from the respective PPC channels.

In one more aspect, a computer-readable medium is disclosed. The medium includes code for causing a processing unit to receive at least one transmission frame from a transmitter, wherein the transmission frame includes transmitter specific information placed within one of a data flow in the at least one transmission frame and a control channel of the at least one transmission frame, wherein the transmitter specific information includes location information about at least one transmitter. The medium further includes code for causing a processing unit to receive the at least one transmission frame and at least one other of a plurality of transmission frames, each including a PPC channel having a respective encoded transmitter identifier. Finally, the medium includes code for causing a processing unit to decode the at least one transmission frame and the at least one other of the plurality of transmission frames to determine the transmitter specific information from one of the data flow and the control channel, and to determine transmitter identifiers from the respective PPC channels.

### BRIEF DESCRIPTION OF THE DRAWINGS

FIG. 1 illustrates a communication network that may employ a disclosed transmitter identification scheme.

FIG. 2 illustrates an example of a communication system featuring transmission of transmitter identification information.

FIG. 3 shows a transmission superframe that may be used in the systems of FIGS. 1 or 2.

FIG. 4. is a call flow diagram illustrating an example of messaging between different elements in a communication system to effect positioning services with transmitter specific data transmitted in a data flow.

FIG. 5. is a flow diagram of an exemplary mechanism to determine an identifier for the positioning information flow for PPC Positioning Service.

FIG. 6. illustrates an exemplary Transmitter Information Message for conveying transmitter specific information via a Control Channel.

FIG. 7 illustrates an example of various fields in a Control Protocol Packet (CPP) header used in packets of the Transmitter Information Message of FIG. 6.

FIG. 8 is a call flow diagram illustrating an example of messaging between different elements in a communication system to effect positioning services with transmitter specific data transmitted in a Control Channel.

FIG. 9 shows a flow diagram illustrating a method for communicating transmitter specific information in a communication system.

FIG. 10 illustrates an apparatus for communicating transmitter specific information in a communication system.

FIG. 11 shows a flow diagram illustrating a method for receiving transmitter specific information in a communication system.

FIG. 12 illustrates an apparatus for receiving transmitter specific information in a communication system.

### DETAILED DESCRIPTION

The present disclosure relates to methods and apparatus for communicating transmitter specific information concerning a transmitter in a broadcast communication system. Each transmitter in a broadcast communication system is configured to be able to transmit a transmitter identification (hereinafter referred to as a “transmitter ID”), as well as other information about the transmitter within transmission frames (e.g., FLO superframes) to receiver devices, such as user equipment or mobile user devices. A receiver, such as a receiver in a mobile user device, can then use the transmitter specific information and propagation delays measured using PPC symbols to determine its position, for example. The present disclosure specifically relates to communicating the transmitter specific information, such as information relating to the transmitter location, via portions of the transmission frame apart from the PPC symbols. In the disclosed examples, the transmitter specific information may be transmitted in data flows or control channels within one or more superframes.

For purposes of the following detailed description, the disclosed examples are described herein with reference to a broadcast communication network that utilizes Orthogonal Frequency Division Multiplexing (OFDM) to provide communications between network transmitters and one or more mobile devices, such as FLO or DVB-H. In an example, the disclosed communication systems may employ the concept of Single Frequency Network (SFN), where the signals from multiple transmitters in the network carry the same content or services. As a result, the waveforms can be viewed by a receiver as if they are signals from the same source with different propagation delays.

It is further noted that an exemplary OFDM system disclosed herein utilizes superframes. Superframes include data symbols organized into data slots and frames that are used to transport services from a server via transmitters to receiving devices. According to an example, a data slot may be defined as a set of a predetermined number of data symbols (e.g., 500) that occur over one OFDM symbol time. Additionally, an OFDM symbol time in the superframe may carry, as merely an example, eight slots of data.

According to a further example, a PPC in a superframe includes PPC symbols that are used to communicate the transmitter ID, which allows individual transmitters in the network to be determined or differentiated by user equipment or mobile devices. Furthermore, the PPC symbols may be used for positioning services by measuring PPC signal delays from all nearby transmitters to determine distances there from followed by triangulation techniques to determine device location. In an exemplary system, the superframe boundaries at all transmitters may be synchronized to a common clock reference. For example, the common clock reference may be obtained from a Global Positioning System (GPS) time reference. A receiving device may then use the PPC symbols to identify a particular transmitter and respective channel estimates from a set of transmitters in the vicinity of the receiving device.

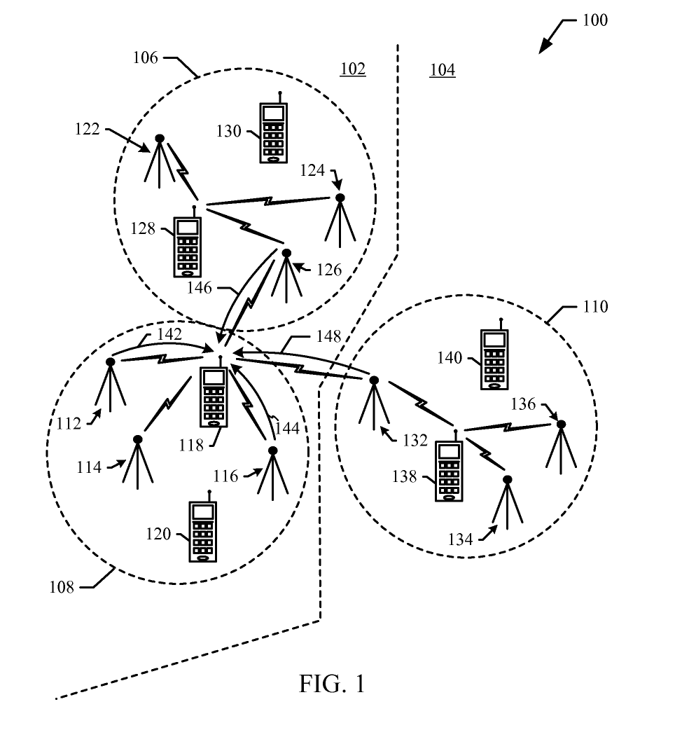

FIG. 1 illustrates a communication network 100 in which the presently disclosed methods and apparatus may be employed. The illustrated network 100 includes two wide area regions 102 and 104. Each of the wide area regions 102 and 104 generally covers a large geographical area, such as a state, multiple states, a portion of a country, an entire country, or more than one country. In turn, the wide area regions 102 or 104 may include local area regions (or sub-regions). For example, wide area region 102 includes local area regions 106 and 108 and wide area region 104 includes local area region 110. It is noted that the network 100 illustrates just one network configuration and that other network configurations having any number of wide area and local area regions may be contemplated.

Each of the local area regions 106, 108, 110 includes one or more transmitters that provide network coverage to mobile devices (e.g., receivers). For example, the region 108 includes transmitters 112, 114, and 116, which provide network communications to mobile devices 118 and 120. Similarly, region 106 includes transmitters 122, 124, and 126, which provide network communications to devices 128 and 130, and region 110 is shown with transmitters 132, 134, and 136, which provide network communications to devices 138 and 140.

As illustrated in FIG. 1, a receiving device may receive superframe transmissions including PPC symbols from transmitters within its local area, from transmitters in another local area within the same wide area, or from transmitters in a local area outside of its wide area. For example, device 118 may receive superframes from transmitters within its local area 108, as illustrated by arrows 142 and 144. Device 118 may also receive superframes from a transmitter in another local area 106 within wide area 102, as illustrated by arrow 146. Device 118 potentially may further receive superframes from a transmitter in local area 110, which is in another wide area 104, as illustrated at 148.

It is noted that an active transmitter is a transmitter that transmits a PPC symbol, which includes transmitter identification (transmitter ID) information using at least a portion of the subcarriers (e.g., an interlace). Only one active transmitter is allocated on each active symbol, however, it is possible to allocate any number of active symbols to a transmitter. Thus, each transmitter is associated with an “active symbol” with which the transmitter transmits information including identifying information. When a transmitter is not in the active state, it transmits on a defined idle portion (e.g., interlace) of the PPC symbol. Receiving devices in the network can then be configured to not “listen” for information in the idle portion of the PPC symbols. This allows transmitters to transmit during the idle portion of the PPC symbols to provide power (i.e., energy per symbol) stability to maintain network performance. In a further example, symbols transmitted on the PPC are designed to have a long cyclic prefix (CP) so that a receiving device may utilize information from far away transmitters for the purpose of position determination. This mechanism allows a receiving device to receive identification information from a particular transmitter during its associated active symbol without interference from other transmitters in the region because other transmitters are transmitting on the idle portion (interlace) of the symbol.

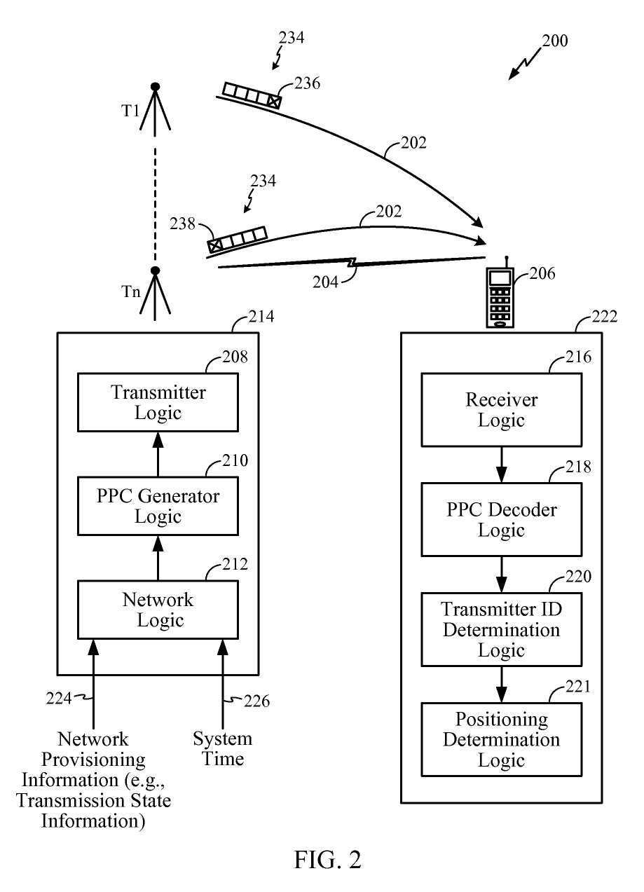

FIG. 2 shows an example of a communication system 200 that includes positioning services. According to the present disclosure, the positioning services afford the ability to a device to determine its location by using the PPC channel as well as conveyed transmitter specific information, which may include, but is not limited to, the transmitter ID, as well as transmitter location or power information specific to the transmitter.

System 200 includes a plurality of transmitters (e.g., transmitters T1 through Tn) that transmit superframes including a positioning pilot channel (PPC) 202 over a wireless link 204 to at least one receiving device 206. The transmitters T1-Tn may represent those transmitters that are nearby to the device 206 and may include transmitters within the same local area as the device 206, transmitters in a different local area, or transmitters in a different wide area. It is noted that the transmitters T1-Tn may be part of a communication network synchronized to a single time base (e.g., GPS time) such that the superframes transmitted from the transmitters T1-Tn are aligned and synchronized in time. Note that it is possible to allow for a fixed offset of the start of superframe with respect to the single time base and account for the offset of the respective transmitters in the determination of the propagation delay. Thus, the content of the transmitted superframes may be essentially identical for transmitters within the same local area, but may be different for transmitters in different local or wide areas, however, because the network is synchronized, the superframes are aligned and the receiving device 206 can receive symbols from nearby transmitters over the PPC 202 and those symbols are also aligned.

Each of the transmitters T1-Tn may functionally comprise transmitter logic 208, PPC generator logic 210, and network logic 212, or equivalents as illustrated by exemplary transmitter block 214. Receiving device 206 may include receiver logic 216, PPC decoder logic 218, and transmitter ID determination logic 220, as illustrated by exemplary receiving device block 222.

The transmitter logic 208 may comprise hardware, software, firmware, or any suitable combination thereof. Transmitter logic 208 is operable to transmit audio, video, and network services using the transmission superframe. The transmitter logic 208 is also operable to transmit one or more PPC symbols in a superframe. In an example, the transmitter logic 208 transmits one or more PPC symbols 234, which are within a superframe, over the PPC 202 to provide transmitter identification information for use by the receiving device 206 to identify particular transmitters, as well as for other purposes such as positioning services.

The PPC generator logic 210 comprises hardware, software, firmware or any combination thereof. PPC generator logic 210 operates to incorporate transmitter specific information into the symbols 234 transmitted over the PPC 202, as well as within other portions of the superframe such as the data flow or control channels as will be discussed in further detail later. In an example, each PPC symbol comprises a plurality of subcarriers that are grouped into a selected number of interlaces. An interlace, in turn, may be defined as a set or collection of uniformly spaced subcarriers spanning the available frequency band. It is noted that interlaces may also consist of a group of subcarriers that are not uniformly spaced.

In an example, each of the transmitters T1-Tn is allocated at least one PPC symbol that is referred to as the active symbol for that transmitter. For example, the transmitter T1 is allocated PPC symbol 236 within the PPC symbols 234 in a superframe, and the transmitter Tn is allocated PPC symbole 238 within the PPC symbols 234 in a superframe.

The PPC generator logic 210 operates to place or encode the transmitter ID into the active symbol for that transmitter. For example, the interlaces of each symbol are grouped into two groups referred to as “active interlaces” and “idle interlaces.” The PPC generator logic 210 operates to encode transmitter identification information on dedicated active interlaces of the active symbol for that transmitter. For instance, the transmitter T1 identification information is transmitted on the active interlaces of the symbol 236, and the transmitter Tn identification information is transmitted on dedicated active interlaces of the symbol 238. When a transmitter is not transmitting its identification on the active symbol, the PPC generator logic 210 operates to encode idle information on idle interlaces of the remaining symbols. For example, if the PPC 202 comprises ten symbols, then in an SFN network up to ten transmitters will each be assigned one PPC symbol as their respective active symbol. Each transmitter will encode identification information on the active interlaces of its respective active symbol, and will encode idle information on the idle interlaces of the remaining symbols. It is noted that when a transmitter is transmitting idle information on the idle interlaces of a PPC symbol, the transmitter logic 208 operates to adjust the power of the transmitted symbol to maintain a constant energy per symbol power level.

PPC generator logic 210 also operates to place, insert, or encode the transmitter specific information into the superframes transmitted by that transmitter 214. The transmitter specific information may include, but is not limited to, transmitter location information such as latitude and longitude, transmitter altitude information, network delay of the transmitter, and transmitter power. The transmitter specific information will also include the transmitter ID in order to correlate the location information about the transmitter to the PPC symbol also conveying the transmitter ID in the PPC channel. In one presently disclosed aspect, the transmitter specific information may be placed or encoded into a higher layer data flow (or flows) transmitted via the superframes. In another disclosed aspect, the transmitter specific information may be inserted, placed or encoded into the Control Channel within the superframe.

The network logic 212 may be configured by hardware, software, firmware, or any combination thereof. The network logic 212 is operable to receive network provisioning information 224 and system time 226 for use by the system. The provisioning information 224 is used to determine an active symbol for each of the transmitters T1-Tn during which each transmitter is to transmit identification information on their active symbol's active interlaces. Provisioning information 224 also includes transmitter specific information, as well as further location assistance information, which will be discussed in more detail later. The system time 226 is used to synchronize transmissions so that a receiving device is able to determine a channel estimate for a particular transmitter as well as aid in propagation delay measurements.

The receiver logic 216 comprises hardware, software, firmware or any combination thereof. The receiver logic 216 operates to receive the transmission superframe including PPC symbols 234 on the PPC 202 from nearby transmitters. The receiver logic 216 operates to receive the superframes, including the transmitter specific information in either a data flow or the Control Channel of at least some of the superframes, as well as PPC symbols 234 in the superframes (along with a transmitter ID determination logic 220 that obtains the transmitter IDs from PPC symbols 234) and pass them on to the positioning determination logic 221.

The PPC decoder logic 218 comprises hardware, software, firmware or any combination thereof. The PPC decoder logic 218 operates to decode the PPC symbols to determine the identity of a particular transmitter associated with each symbol. For example, the decoder logic 218 operates to decode the received active interlaces of each PPC symbol to determine the identity of a particular transmitter associated with that symbol (with the assistance of transmitter ID determination logic 220, as one example). Once a transmitter identity is determined, the PPC decoder logic 218 operates to determine a channel estimate for that transmitter. For example, using a time reference associated with the received superframe, the PPC decoder logic 218 can determine a channel estimate for the active transmitter associated with each received PPC symbol. Thus, the PPC decoder logic 218 operates to determine a number of transmitter identifiers and associated channel estimates. This information is then passed on to the position determination logic 221.

The position determination logic 221 comprises hardware, software, firmware or any combination thereof. In an aspect, the positioning determination logic 221 operates to calculate a position of the device 206 based on the decoded transmitter identification information and associated channel estimates received from the PPC decoder logic 218. For example, the locations of the transmitters T1-Tn are known to network entities. The channel estimates are used to determine the device's distance from those locations (e.g., the signal propagation delay may be determined). The positioning determination logic 221 then uses triangulation techniques to triangulate the position of the device 206.

During operation, each of the transmitters T1-Tn encodes transmitter identification information on at least one of the active interlaces of an active PPC symbol associated with that transmitter. The PPC generator logic 210 operates to determine which symbol is the active symbol for a particular transmitter based on the network provisioning information 224. When a transmitter is not transmitting its identification information on the active interlaces of its active symbol, the PPC generator logic 210 causes the transmitter to transmit idle information on the idle interlaces of the remaining PPC symbols. Because each transmitter is transmitting energy in each PPC symbol, (i.e., either on the active or idle interlaces) transmitter power does not experience fluctuations that would disrupt network performance.

When the device 206 receives the PPC symbols 234 over the PPC 202 from the transmitters T1-Tn, it decodes the transmitter IDs from the active interlaces of each PPC symbol. Once a transmitter is identified from each PPC symbol, the device 206 is able to determine a channel estimate for that transmitter based on the available system timing. The device 206 continues to determine channel estimates for the transmitters it identifies until channel estimates for a number of transmitters (e.g., preferably four estimates) are obtained. Based on these estimates, the positioning determination logic 221 may determine signal delay. This delay in combination with the transmitter specific information (e.g., the transmitter location information) allows logic 221 to determine distances to a sufficient number of transmitters from T1-Tn to determine the position of device 206 using triangulation techniques. In another example, the positioning determination logic 221 operates to transmit the transmitter identifiers and associated channel estimates to another network entity that performs the triangulation or other positioning algorithms to determine the device's position.

In an example, positioning services utilize a computer program having one or more program instructions (“instructions”) stored on a computer-readable medium, which when executed by at least one processing unit, provides the functions of the positioning services described herein. For example, instructions may be loaded into the PPC generator logic 210 and/or the PPC decoder logic 218 from a computer-readable medium, such as a floppy disk, CDROM, memory card, FLASH memory device, RAM, ROM, or any other type of memory device. In another example, the instructions may be downloaded from an external device or network resource. The instructions when executed by at least one processing unit operate to provide examples of positioning services as described herein.

In addition, it is noted here that the positioning services utilize transmitters to determine an active PPC symbol in which a particular transmitter is to transmit its identifying information on the active interlaces of that symbol. The transmitters also serve to convey transmitter specific information that is used, among other things, for the positioning services. The positioning services also operate in receiving devices to determine channel estimates for transmitters identified in the received PPC symbols and perform triangulation techniques to determine a device position with the used of conveyed transmitter specific information.

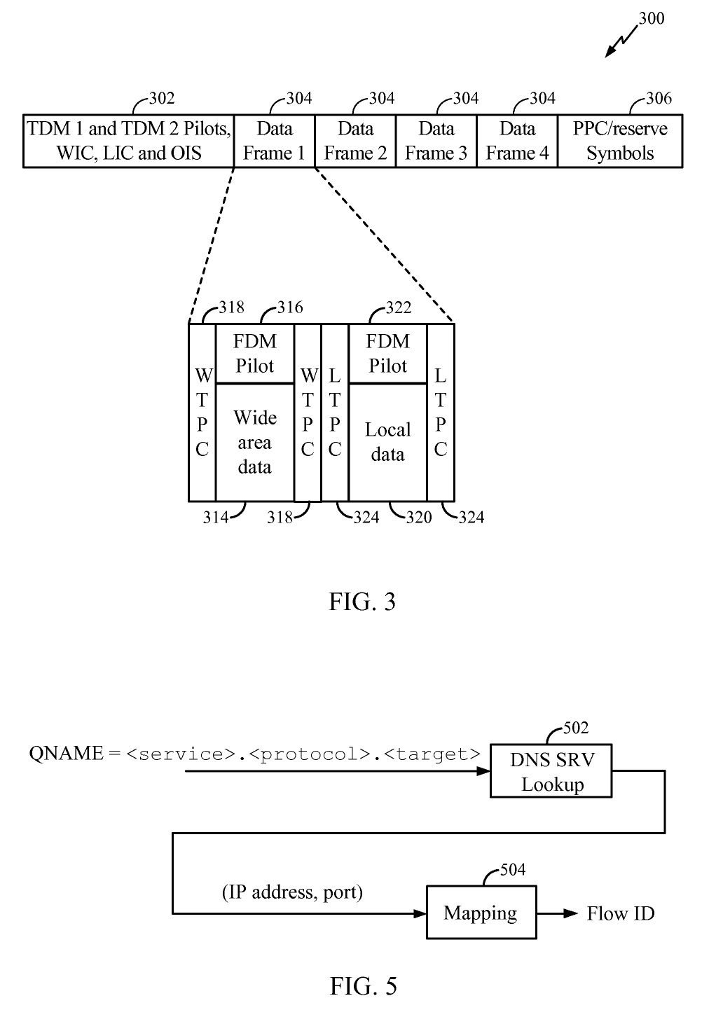

FIG. 3 shows a transmission superframe 300 that may be used in the systems of either FIGS. 1 or 2. As shown, each superframe 300 includes prefatory channels 302 including time division multiplexed (TDM) pilots (e.g., TDM1 and TDM2), Wide Area Identification Channel (WIC), Local Area Identification Channel (LIC), and overhead information symbols (OIS). The superframe 300 also includes one or more data frames 304 (e.g., four data frames in the example of FIG. 3 for a MediaFLO system), and lastly PPC/reserve symbols 306.

FIG. 3 also shows an expansion of a data frame 304, which may contain wide area data 314 pertaining to services offered via a wide area network (e.g., see wide areas 102 or 104 in FIG. 1). Associated with the wide area data 314 is wide area Frequency Division Multiplexed (FDM) pilot data 316. The wide area data 314 and FDM pilot data 316 are preceded and followed by wide area transition pilot channels (WTPC) 318, which serve to signal the start and end of the wide area data 314. Similarly, each data frame 304 also includes local data 320 pertaining to services offered in a local area network (e.g., see local areas 106, 108, 110). An associated local FDM pilot channel 322 is included with data 320, both of which are preceded and followed by local area transition pilot channels (LTPC) 324.

In an aspect of the present disclosure, it is noted that the transmitter specific information used in positioning services may be conveyed by either a data flow or a Control Channel. In either case, the data flow or Control Channel, which are higher layer conventions, are mapped to a Media Access Control (MAC) layer, and then further mapped to one or both of the wide area data 314 and local area data 320 at the physical layer. In a further aspect in the case of data flow conveyance, a particular positioning information flow may be mapped to data portions of the data frames 304 in one superframe or across multiple superframes. The positioning information flow includes positioning information messaging within the flow to communicate the transmitter specific information. In the case of conveyance via a Control Channel, a message within the Control Channel utilizing known control protocols may be added, where control packets at the MAC layer are mapped to data portions of the data frames 304 in one superframe or across multiple superframes.

Turning specifically to the example of conveying transmitter specific information via a data flow, the positioning information messaging containing the transmitter specific information, from a higher level perspective, can be based in XML or other similar markup language, or any other suitable programming format to communicate data. As an example, the transmitter specific information is transmitted in a “Positioning Information Message” in the positioning information data flow. The message can be XML based wherein the Positioning Information Message may be configured to include the transmitter specific information (e.g., transmitter ID and specific data concerning the identified transmitter such as transmitter longitude, transmitter latitude, network delay for the transmitter, or transmitter power). Additionally, the Positioning Information Message may include attributes of the message, such as a version and an identification of the area (area ID) to which the Positioning Information Message applies.

It is noted here that in some situations, basic positioning service based on triangulation with PPC symbols and the transmitter specific information does not yield a precise location of the device. One such situation may occur if a device does not detect enough transmitters in an area. In this case, the position or location determination will not be accurate. For example, in some systems such as MediaFLO a device may need to detect at least four transmitters in order to accurately determine its location. Another situation diminishing positioning accuracy is when a device may not have line of sight to some of the transmitters, which can result in the measured distances to those transmitters being inaccurate.

Accordingly, in an aspect of the presently disclosed methods and apparatus, the information sent to a device can be configured to include assistance data to help the device resolve any ambiguities in the position estimated by the triangulation method. As examples, the assistance data may include geographic map data, topographic data, altitude patterns of a geographic area, terrain, or topological data, such as those concerning the transmitter area of a transmitter.

The assistance data may be included within the positioning information data flow and, in particular, with the Positioning Information Message along with the transmitter specific information, or may be included within other data flows among transmitted superframes. At a higher level, in the former case, the Positioning Information Message may include an assistance data element containing the assistance data. In the latter case, the Positioning Information Message may include an assistance data flow identifying element specifying an ID (“Assistance Data Flow ID) of the separate assistance data flow in which the assistance data is transmitted.

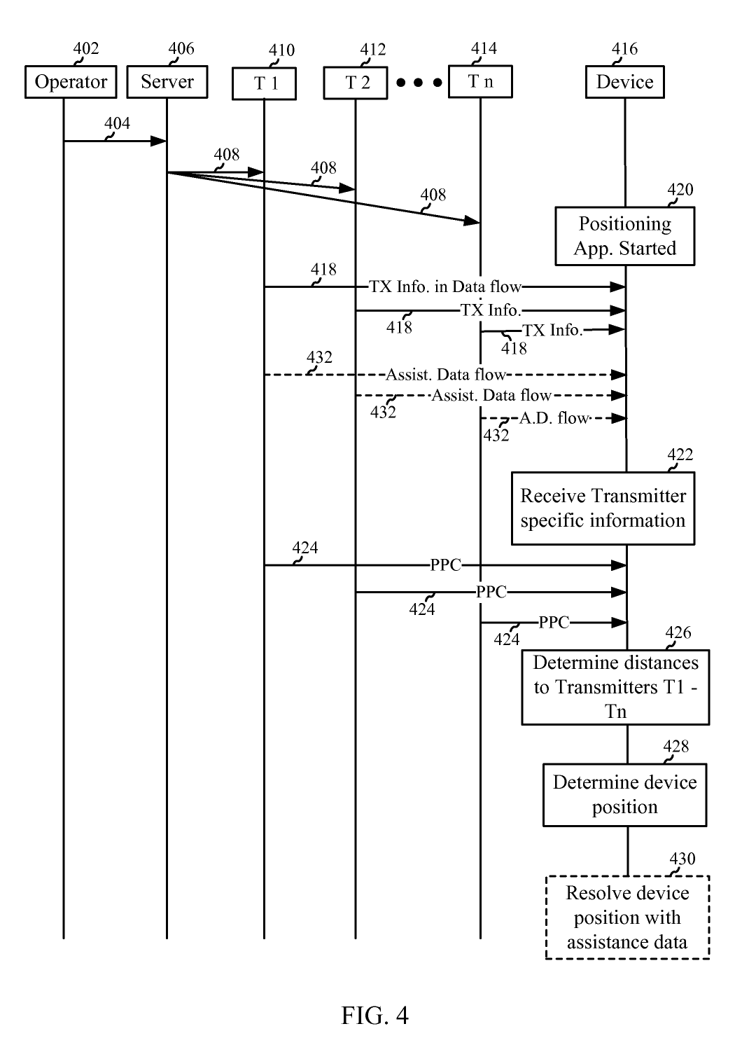

FIG. 4 shows a call flow diagram that illustrates an example of messaging between different elements in a communication system that may effect positioning services with transmitter specific data transmitted in a data flow. As shown, an operator 402 may first provision transmitter information including transmitter specific information (as well as assistance data in an alternative) for positioning services 404 to a network server 406. As described before, the transmitter specific information includes information such as transmitter ID, longitude, latitude, altitude and network delay on the server, as well as assistance data, if provided.

Server 406 then distributes the transmitter specific information through messages 408 over the communication network to one or more transmitters T1 through Tn (e.g., 410, 412, 414). The transmitters T1 through Tn, in turn, then configure the transmitter specific information for transmission of the transmitter specific information in a data flow to one or more user devices 416, as indicated by transmissions or data flows 418. Given the example above, the transmissions or data flows 418 may be a specific positioning information flow containing Positioning Information Messages conveying, among other things, the transmitter specific information.

In one aspect, each transmitter T1 through Tn may transmit its own unique Positioning Information Message. In another aspect, one of the transmitters T1 through Tn may transmit a single positioning information data flow 418 that includes the transmitter specific information for each of transmitters T1-Tn. In still another aspect, any of transmitters T1 through Tn can transmit one or multiple unique Positioning Information Messages on the Positioning Information Flow. In the latter case, each unique Positioning Info Message corresponds to one area, such as transmitting information about the transmitters in the local and neighboring areas. The transmission of the Positioning Information Message(s) is repeated by one or more of transmitters T1-Tn. As transmitter location is normally static, it is noted that in an aspect the Positioning Information Message does not need to be repeated as frequently (e.g., the transmitter specific information does not need to be sent with each superframe).

Upon start up of device 416, or at least prior to or concurrent with transmission of the messages 418, the device 416 may initiate a positioning application as indicated in block 420. In some cases, the identifier of the positioning information flow may be well known, and thus device 416 may know how to locate the positioning information flow in the received data. In other cases, the positioning information flow may not be well known, and thus device 416 may need to discover the positioning information flow in the received data.

In the case where positioning information data flow is not well known, in one exemplary implementation the device 416 may be configured to initiate a lookup of the positioning information flow via a discovery mechanism. In one example, the discovery mechanism involves a Domain Name System (DNS) lookup or similarly suitable hierarchical naming system lookup to determine an identifier (ID) for positioning information data flow. The DNS servers in the communication network, of which device 416 and transmitters T1-Tn are included, may have Service or SRV records for the PPC based positioning service.

In one particular aspect, the SRV records may include having the Service name represented as QNAME (DNS Query Name). The QNAME's format is <service>.<protocol>.<target> where the <service> is the symbolic name of the desired service, the <protocol> is the symbolic name of the desired transport protocol and the <target> is the domain name of the target host that provides the service. The <service> and <protocol> are prefixed by an underscore (_) to avoid collision with DNS labels that occur in nature. One example QNAME for the PPC Positioning Service could be _ppcpos._mflomip.mediaflo.com. The SRV records also include a multicast IP address and port number for the flow corresponding to the service; namely PPC positioning service or positioning information data flow.

A flow diagram of an exemplary mechanism to determine an identifier for the positioning information flow (e.g., flow 418 in FIG. 4) for the PPC Positioning Service is illustrated in FIG. 5. The device 416 will first utilize the desired service's QNAME to perform a DNS SRV lookup 502 (e.g., _ppcpos._mflomip.mediaflo.com) via the DNS servers in the network. The result of lookup 502 yields a corresponding IP address and port number of the records for the PPC based positioning service. Device 416 then uses a predetermined methodology to map the IP address and port number to a flow identifier (ID) as shown by block 504. In one example, the mapping of block 504 is a one to one mapping.

Turning back to FIG. 4, device 416 may also first compare a version of the transmitter specific information for an area to that of the locally stored positioning info for the same area to check if it has the latest positioning information for the area. If not, device 416 will update its transmitter specific information for the area with the one received from the Positioning Information Flow 418. Furthermore, device 416 may be configured to learn the versions and areas of the transmitted transmitter specific information by periodically receiving data from the positioning information flow 418 from one or more of the transmitters. If the system has a meta-data flow (not shown) transmitting the versions and areas of the positioning info on the Positioning Information Flow, device 416 can learn the versions and areas of the transmitted positioning info by periodically receiving data from the meta-data flow.

After receiving transmitter specific information (e.g., block 422) via the data flow 418, device 416 calculates distances to the detectable transmitters by measuring the propagation delays of PPC signals 424 from the transmitters as shown by block 426. As noted before, the device 416 will also receive each detectable transmitter's ID from the corresponding PPC signal. Once the distances to the detectable transmitters have been determined by the device 416, the device may then correlate the IDs of the detected transmitters to the transmitter specific information received in data flow(s) 418 to look up the location information, and other pertinent information in the transmitter specific information, to obtain the transmitters' positions. Device 416 may then use the positions of the detected transmitters and the calculated distances to the transmitters with triangulation techniques to estimate its position as shown by block 428.

In those cases where ambiguities in the determined position of a device might arise, the system of FIG. 4 may be further configured such that one or more of the transmitters repeatedly transmit a flow for assistance data. In one option, the assistance data flow may be included as part of the data flow 418 and even part of a same Positioning Information Message in that flow. In such case, after a PPC positioning application on the device 416 starts up (e.g., block 420) assistance data is also received respectively from one or more of the transmitters. Accordingly, when device 416 has received the assistance data, position ambiguity resolution may also be performed as shown by block 430.

If the assistance data flow is separate from the data flow for the transmitter specific data (e.g., the Positioning Information Flow), as shown by arrows 432 in FIG. 4, an identifier for the assistance data flow (e.g., an “Assistance Data Flow ID”) may be transmitted with positioning information message. This message allows the device 416 to locate the assistance data flow 432 in order to obtain the assistance data there from.

In another alternative, rather than transmitting the transmitter specific information via a data flow, this data may instead be transmitted via the Control Channel in the control layer across one or more superframes. The control layer, which in some systems such as MediaFLO, is normally used to disseminate control information facilitating operation of a device (e.g., 416), and the location of the control channel(s) in the superframe are communicated in the OIS information in preface (e.g., 302 in FIG. 3) of the superframe.

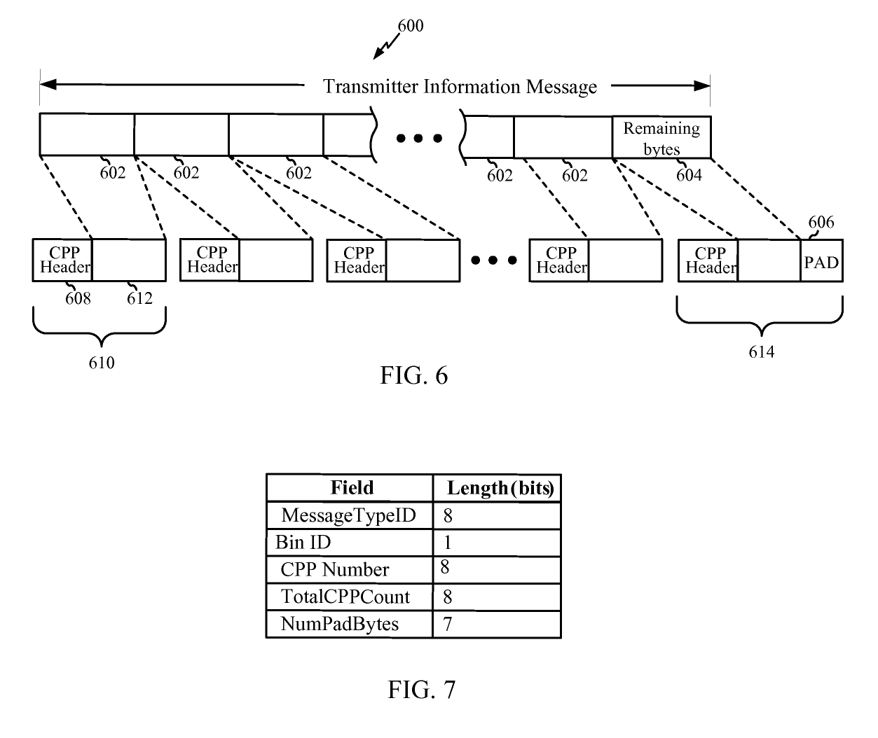

FIG. 6 illustrates one example of how the transmitter specific information, communicated via a Transmitter Information Message 600 (which is analogous to the “Positioning Information Message” discussed above) that is conveyed in the Control Channel. The message 600 is separated into fragments 602, where each fragment except for the last one 604 has a fixed size of a predetermined number of bytes (e.g., 118 bytes for a MediaFLO system). If the remaining bytes of the message placed in the last fragment 604 are not equal to the predetermined number of bytes for a fragment, it can be padded (See field 606) to ensure the fragment 604 contains the predetermined number of bytes to match the other fragments 602.

Each fragment 602, 604 in message 600 may be also prefixed with a four (4) byte or 32 bit Control Protocol Packet (CPP) header 608, as one example, to form a Control Protocol Packet (CPP) 610 consisting of the header 608 and the payload data 612. Each header 608 contains various fields with a corresponding length or allocation of the 32 bits, as exemplified in FIG. 7. The various fields communicate information such as the message type (MessageTypeID), an identification of the bin, the particular number of that CPP, a total count of the number of CPPs in the message, and a number of padding bytes, such as in the case of CPP 614, for example.

The transmitter information message 600 may be formatted to include various data as illustrated in Table 1 below.

TABLE 1

| Field Name | Description |
|---|---|
| MESSAGE_VERSION | Version of the Transmitter |
| | Information Message. |
| TRANSMITTER_COUNT | Number of the transmitters for which |
| | the message carries information |

TRANSMITTER_COUNT instances of the following fields

| | |
|---|---|
| TRANSMITTER_ID | Identification of the transmitter |
| TRANSMITTER_LATITUDE | Latitude of the transmitter |
| TRANSMITTER_LONGTITUDE | Longitude of the transmitter |
| TRANSMITTER_ALTITUDE | Altitude of the transmitter |
| NETWORK_DELAY | Network delay of the transmitter |
| TRANSMITTER_POWER | Power of the transmitter |
| TRANSMITTER_HEIGHT | Height of transmitter from base |
| | of transmitter |
| REPEATERS | Whether repeater transmitters are |
| | present (or absent in transmitter |
| | coverage region) |

As can be seen in Table 1, the transmitter information message may include a message version (MESSAGE_VERSION) field communicating the version of the message. Accordingly, a receiving device (e.g., device 416) may use the version to decide if it has the latest transmitter information. Additionally, the message may include a transmitter count (TRANSMITTER_COUNT), which indicates the number of transmitters for which the message carries transmitter specific information. In an alternative, if each transmitter T1 through Tn transmits its own transmitter information message in their respective Control Channels, this field could be omitted, as other transmitters will transmit information specific to those transmitters.

Table 1 also shows that the transmitter information message may include various data fields concerning the transmitter specific information, which are repeated for each respective transmitter in the transmitter count (TRANSMITTER_COUNT). For example, if there are five transmitters T1-T5 (TRANSMITTER_COUNT=5) for which the transmitter information message carries transmitter specific information, then there would be five instances of each data field for each respective transmitter. Similar to the examples discussed before, the transmitter specific information may include the transmitter ID, latitude and longitude of the transmitter, the transmitter altitude, network delay, and transmitter power. Other fields that could be included are transmitter height (height of transmitter from base), and a flag indicating if repeater transmitters are present or not in a transmitter coverage area, as also shown in Table 1. One skilled in the art will appreciate that the fields are exemplary and not limited to such, but that various other data fields may also be included.

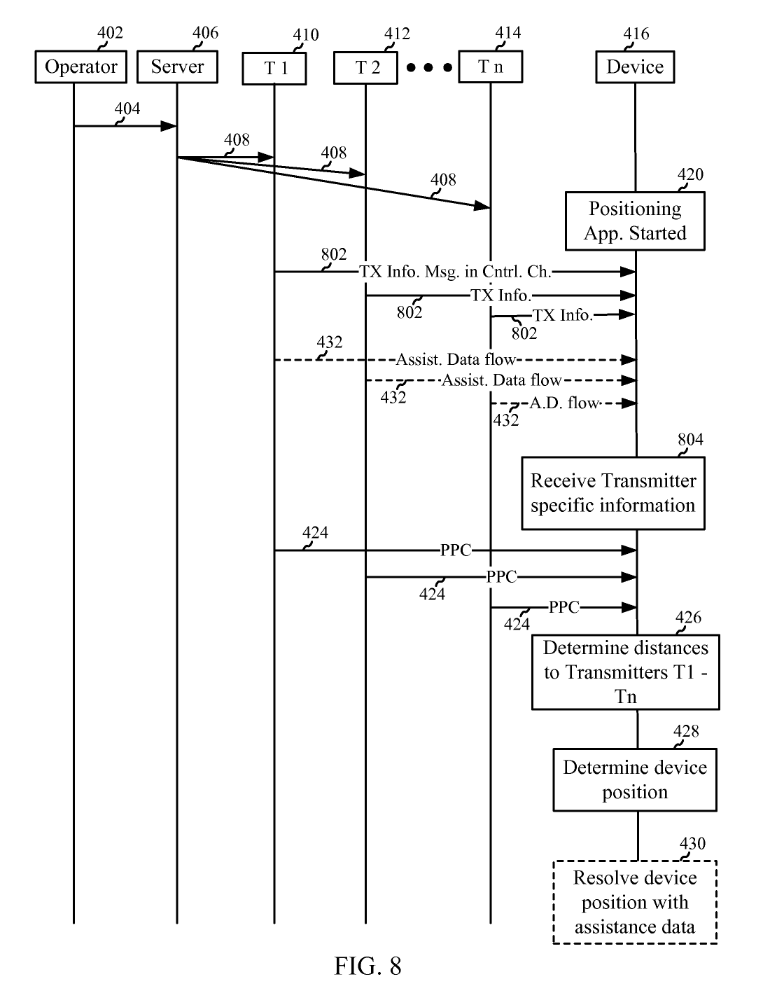

FIG. 8 illustrates a call flow diagram of an exemplary system where transmitter specific information is conveyed via the control channel. For the sake of brevity, many elements and processes in FIG. 8 are the same as those in FIG. 4. Accordingly, those processes and elements that are the same as FIG. 4 are labeled with the same reference numerals. Only those processes and elements that differ from FIG. 4 will be discussed in the following description.

Turning to FIG. 8, it is noted that after provisioning of transmitter specific information, server 406 may be configured to form the Transmitter Information Message(s) 600, which are then distributed via network transmissions 408 to the transmitters. After receiving the Transmitter Information Messages, the transmitters T1-Tn start to transmit the transmitter specific information via a Transmitter Information Message over the Control Channel as indicated by arrows 802 from the respective transmitters. It is noted that in an alternative, only one of transmitters T1-Tn could be configured to transmit the Transmitter Information Message to device 416, where the message contains a number of instances of the transmitter specific information corresponding to the number of transmitters (i.e., the “n” number of transmitters) as discussed above in connection with Table 1. In an aspect, device 416 receives the latest Transmitter Information Message from the Control Channel using known existing Control Channel data update mechanisms.

After receipt of the message(s) 802 and the associated transmitter specific information therein via the Control Channel as indicated by block 804, device 416 may then calculate its position using the PPC symbols, measurement calculations, and triangulation as discussed before. Furthermore, the assistance data may still be conveyed via messaging in a data flow as illustrated by arrows 432. In a further aspect, however, it is noted that the at least a portion of the assistance data could be conveyed within the Control Channel, either with the transmitter information message 600 or in a separate Control Channel message.

It is also noted that in the system of FIG. 8, since the transmitter specific information is transmitted in the Control Channel, rather than a data flow as in the example of FIG. 4, identification of the assistance data flow (e.g., Assistance Data Flow ID) utilizes a different mechanism. As was discussed before with respect to the system of FIG. 4, XML code was used via the data flow to communicate the Assistance Data Flow ID when the assistance data flow 432 is not well known to device 416. Since the system of FIG. 8 utilizes the Control Channel to convey the transmitter specific information, this may not be possible. Accordingly, device 416 may use the methodology described in connection with FIG. 5 using DNS SRV lookup to determine the Assistance Data Flow ID in order to, in turn, find the assistance data flow 432. A QNAME for this service could be _ppcposassist._mflomip.mediaflow.com for a MediaFLO system, as one example.

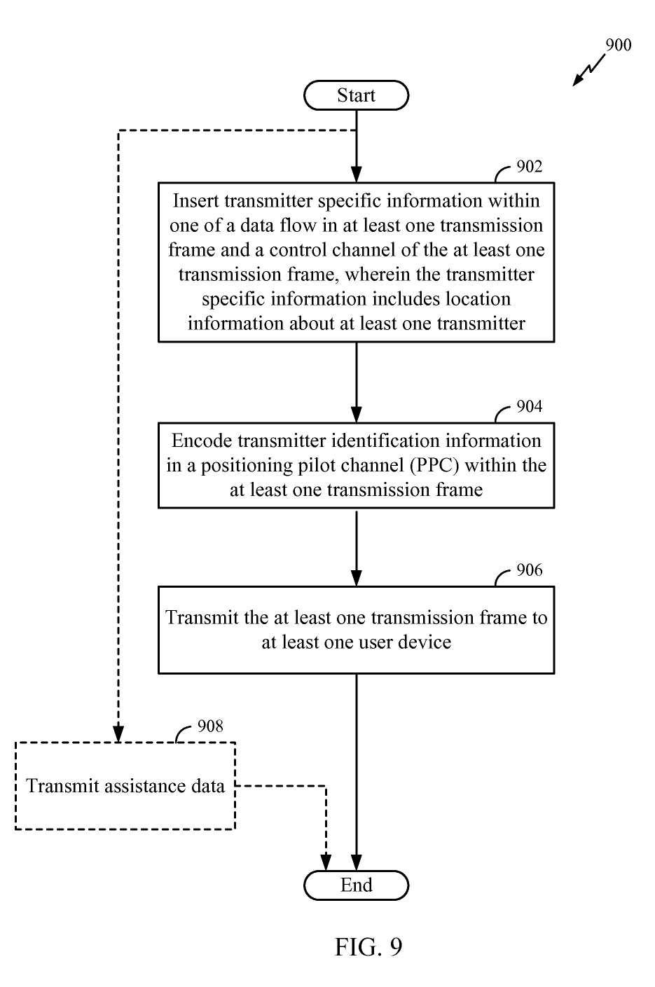

FIG. 9 illustrates a method 900 for communicating transmitter specific information to a device in a communication system. As illustrated, method 900 include a first block 902 where transmitter specific information is inserted within either a data flow in at least one transmission frame (e.g., at least one superframe) or a control channel of the at least one transmission frame. The transmitter specific information includes location information about at least one transmitter. Block 902 may be implemented by one or more of the logic modules in transmitter 214 of FIG. 2, as an example. Additionally, block 902 includes the formation of the positioning information message, in the case of transmission of the transmitter specific information via a data flow (e.g., the positioning information flow). In the case of communication of the transmitter specific information via the Control Channel, the insertion of this information includes formation of the Transmitter Information Message discussed in connection with FIG. 6.

Method 900 also includes block 904 wherein transmitter identification information (i.e., transmitter ID) in a positioning pilot channel (PPC) is also encoded within the at least one transmission frame. Although block 904 is illustrated in FIG. 9 sequentially after block 902, one skilled in the art will appreciate that blocks 902 and 904 need not occur sequentially, but rather may occur concurrently, for example. Block 904 may also be effected by one or more of the logic modules in transmitter 214 of FIG. 2, as an example.

After blocks 902 and 904 are completed, the transmission frame is transmitted to at least one user device (e.g., device 206 of FIG. 2 or 416 of FIGS. 4 and 8) as illustrated by block 906. Transmission may be effected by transmitter logic 208 in a transmitter 214, as one example.

Additionally, in systems providing assistance data for resolving position ambiguities, an optional transmission of assistance data may be also performed as indicated by optional block 908. As explained earlier, this provision of assistance data may be effected by transmission in the same data flow providing the transmitter specific information (in the case of transmission of transmitter specific information by data flow), or in a separate data flow (in the cases of either transmission of transmitter specific information by data flow or Control Channel), or in the Control Channel. The process of block 908 may be implemented by one or more of the logic modules in transmitter 214 of FIG. 2, as an example.

Although method 900 is shown with a termination, one skilled in the art will appreciate that the processes of method 900 are periodically repeated in order to effect ongoing positioning services. The periodicity may be frequent, such as every superframe, or less frequent, such as every few superframes or as determined for a particular broadcast communication system.

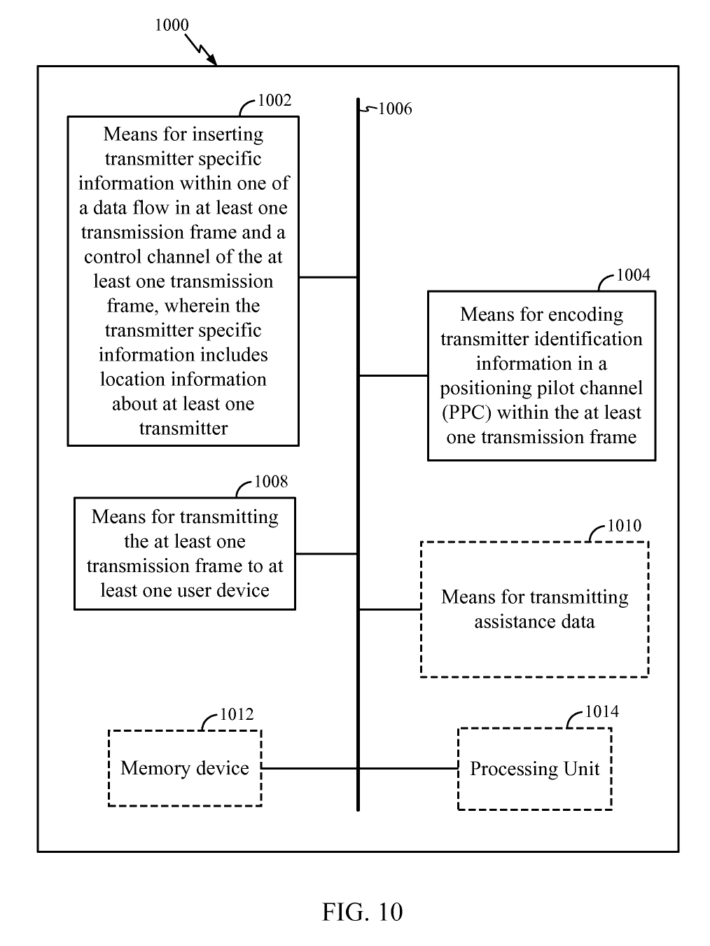

FIG. 10 illustrates an apparatus 1000 that may be employed for communicating transmitter specific information in a broadcast communication system. Apparatus 1000 may be employed at a transmitter, such as 214 from FIG. 2 as merely one example. Apparatus 1000 includes a means 1002 for inserting transmitter specific information within one of a data flow in at least one transmission frame and a control channel of the at least one transmission frame, wherein the transmitter specific information includes location information about at least one transmitter. Means 1002 may be implemented, as an example, by one or more of logic devices 208, 210, and 212, or similar configured devices or logic operable to perform the same equivalent functions.

Apparatus 1000 also includes means 1004 for encoding transmitter identification information in a positioning pilot channel (PPC) within the at least one transmission frame. It is noted that means 1004 may be implemented, as an example, by one or more of logic devices 208, 210, and 212, or similar configured devices or logic operable to perform the same equivalent functions.

Apparatus 1000 is illustrated with a communication bus 1006, or similar suitable communication coupling to visually represent that information, data, or signaling may be passed between the various means or modules in apparatus 1000. In particular, the information inserted or encoded by means 1002 and 1004 is then communicated to a means 1008 for transmitting the at least one transmission frame to at least one user device. Means 1002 may be implemented, as an example, by transmitter logic 208, or similar configured devices or logic operable to perform the same equivalent functions, such as a transmit circuit or ASIC.

Further, apparatus 1000 may include a means 1010 for transmitting assistance data to the user device, which is helpful to resolve position ambiguities when using only the PPC channel symbols and the transmitter specific information. Means 1010 may be implemented with one or more of logic devices 208, 210, and 212, or similar configured devices or logic operable to perform the same equivalent functions.

In addition, apparatus 1000 may include an optional computer readable medium or memory device 1012 configured to store computer readable instructions and data for effecting the processes and functions of one or more of the modules or means in apparatus 1000. Additionally, apparatus 1000 may include a processing unit 1014 configured to execute the computer readable instructions in memory 1012, and may also be configured to execute one or more functions of the various modules in apparatus 1000.

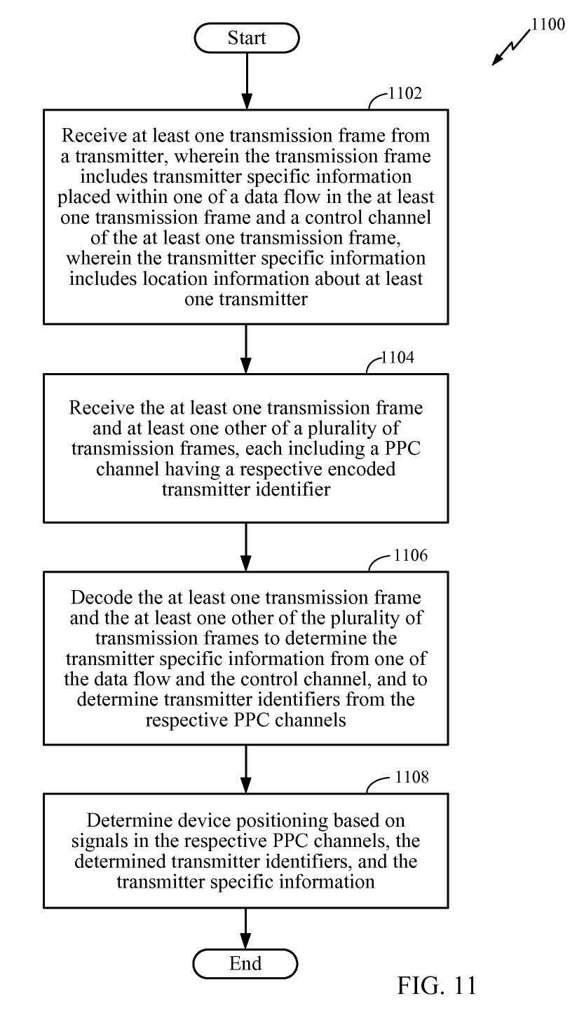

FIG. 11 illustrates a method 1100 that may be employed at a device (e.g., a receiver) to receive communicated transmitter specific information, such as for use in positioning services. Method 1100 includes receiving at least one transmission frame from a transmitter, wherein the transmission frame includes transmitter specific information placed within one of a data flow in the at least one transmission frame and a control channel of the at least one transmission frame as shown in block 1102. The transmitter specific information includes location information about at least one transmitter. As discussed previously, the transmitter specific information for multiple transmitters may be contained within one data flow or Control Channel message, or each transmitter may transmit messages with respective transmitter specific information. Thus, block 1102 contemplates both options. It is noted that block 1102 may be performed by receiver logic 216, as one example, or by any equivalent logic or circuitry operable to perform receiving and decoding functions.

Method 1100 further includes receiving the at least one transmission frame and at least one other of a plurality of transmission frames, each including a PPC channel having a respective encoded transmitter identifier (i.e., transmitter ID) as shown in block 1104. As discussed before, the transmitter IDs obtained from PPC signals from multiple transmitters in a device allow the device to then reference the transmitter specific information for each respective transmitter (e.g., correlation or matching the transmitter ID in the transmitter specific information to transmitter IDs from the PPC channel allow lookup of transmitter specific information for each transmitter as their PPC channel becomes “active”). Block 1104 may be effected by one or more of receiver logic 216, and PPC decoder logic 218, as one example. Although blocks 1102 and 1104 are illustrated in FIG. 11 as sequential, one skilled in the art will appreciate that the processes of these blocks need not occur sequentially, but rather may occur concurrently, for example.

Method 1100 further includes decoding the at least one transmission frame and the at least one other of the plurality of transmission frames to determine the transmitter specific information from one of the data flow and the control channel, and to determine transmitter identifiers from the respective PPC channels as shown in block 1106. The term “decode” as it is used here is meant to broadly include, but is not limited to, channel estimation to obtain PPC symbols and data therein, as well as decoding of superframe data to extract data flow information and Control Channel information according to any various known methods of decoding at the physical layer, as well as processing of data or code at the MAC and higher layers. It is noted that block 1106 may be performed by one or more of PPC decoder logic 218, transmitter ID determination logic 220, and positioning determination logic 221, as examples, or any suitably configured equivalent circuitry or logic operable to perform these processes.

After the communication of the transmitter specific information has been performed via blocks 1102, 1104, and 1106, it is noted that this information may be used to determine positioning of the device as illustrated by block 1108. In particular, a device may determine positioning based on signals in the respective PPC channels, the determined transmitter identifiers, and the transmitter specific information, calculating distances from the device to a plurality of transmitters based on signals in the respective PPC channels, the determined transmitter identifiers, and the transmitter specific information. Further, the final determination of the position of the device is performed with the calculated distances using a predetermined triangulation technique.

Although method 1100 is shown with a termination, one skilled in the art will appreciate that the processes of method 1100 are periodically repeated in a device for positioning. The periodicity may be frequent, such as every superframe, or less frequent, such as every few superframes.

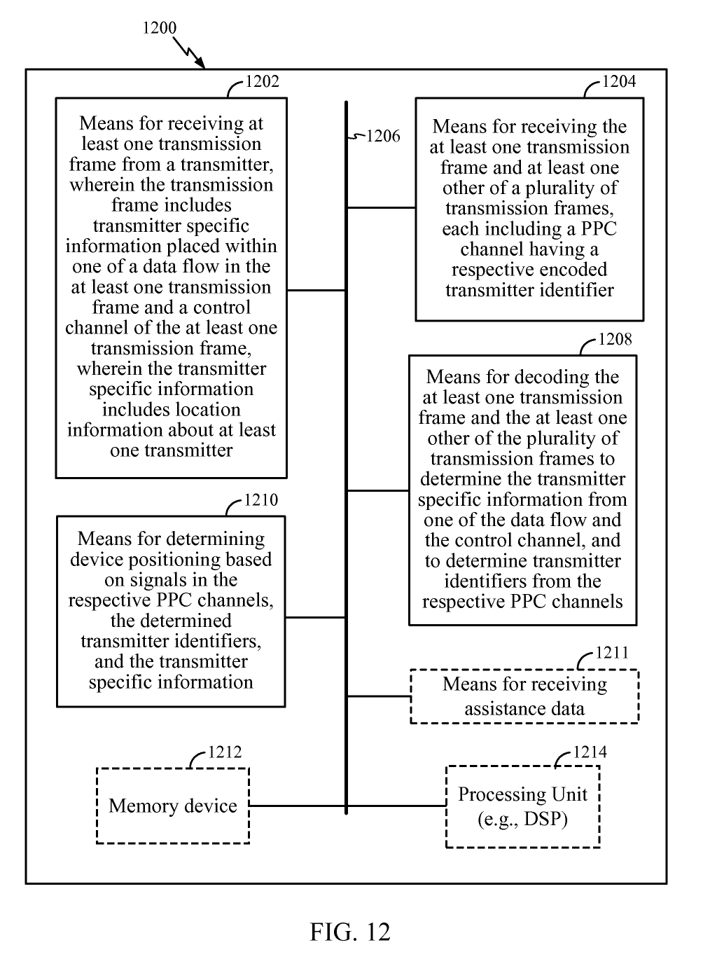

FIG. 12 illustrates an apparatus 1200 for use at receiver (e.g., a user device such as devices 206 or 416), for receiving transmitter specific information in a communication system. Apparatus 1200 includes a means 1202 receiving at least one transmission frame from a transmitter, wherein the transmission frame includes transmitter specific information placed within one of a data flow in the at least one transmission frame and a control channel of the at least one transmission frame. The transmitter specific information includes location information about at least one transmitter. As discussed previously, the transmitter specific information for multiple transmitters may be contained within one data flow or Control Channel message, or each transmitter may transmit messages with respective transmitter specific information. Thus, means 1202 is configured to handle such options. It is noted that means 1202 may be implemented by receiver logic 216, as one example, or by any equivalent logic or circuitry operable to perform receiving and decoding functions.

Apparatus 1200 further includes means 1204 receiving the at least one transmission frame and at least one other of a plurality of transmission frames, each including a PPC channel having a respective encoded transmitter identifier (i.e., transmitter ID). As discussed before, the transmitter IDs obtained from PPC signals from multiple transmitters in a device allow the device to then reference the transmitter specific information for each respective transmitter (e.g., correlation or matching the transmitter ID in the transmitter specific information to transmitter IDs from the PPC channel allow lookup of transmitter specific information for each transmitter as their PPC channel becomes “active”). Means 1204 may be effected by one or more of receiver logic 216, and PPC decoder logic 218, as one example.

Apparatus 1200 is illustrated with a communication bus 1206, or similar suitable communication coupling to visually represent that information, data, or signaling may be passed between the various means or modules in apparatus 1200. In particular, the information received by means 1202 and 1204 is then communicated to a means 1208 for decoding the at least one transmission frame and the at least one other of the plurality of transmission frames to determine the transmitter specific information from one of the data flow and the control channel, and to determine transmitter identifiers from the respective PPC channels.

The term “decode” as it is used here for means 1208 is meant to broadly include, but is not limited to, channel estimation to obtain PPC symbols and data therein, as well as decoding of superframe data to extract data flow information and Control Channel information according to any various known methods of decoding at the physical layer, as well as processing of data or code at the MAC and higher layers. It is noted that the means 1208 may be implemented by one or more of PPC decoder logic 218, transmitter ID determination logic 220, and positioning determination logic 221, as examples, or any suitably configured equivalent circuitry or logic operable to perform these processes.

In particular, a device utilizing apparatus 1200 may include means 1210 for determining positioning based on signals in the respective PPC channels, the determined transmitter identifiers, and the transmitter specific information, calculating distances from the device to a plurality of transmitters based on signals in the respective PPC channels, the determined transmitter identifiers, and the transmitter specific information. Further, the final determination of the position of the device is performed using the calculated distances with a predetermined triangulation technique. Means 1210 may be implemented by positioning determination logic 221, as one example.

Furthermore, apparatus 1200 may include an optional means 1211 receiving assistance data within one of the data flow of the at least one transmission frame and another data flow of the at least one transmission frame, for example. Means 1211 may be implemented by receiver logic, or equivalent logic or circuitry configured to receive the assistance data if needed to resolve position ambiguity.

In addition, apparatus 1200 may include an optional computer readable medium or memory device 1212 configured to store computer readable instructions and data for effecting the processes and functions of one or more of the modules or means in apparatus 1200. Additionally, apparatus 1200 may include a processing unit 1214 configured to execute the computer readable instructions in memory 1212, and may also be configured to execute one or more functions of the various modules in apparatus 1200.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A position/location determination system typically includes a system of transmitters positioned to enable entities to determine their location on or above the Earth based, at least in part, on signals received from the transmitters. Such a transmitter may transmit a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). For a satellite positioning system (SPS), the techniques are not restricted to global systems (e.g., GNSS). For example, the techniques may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, an SPS may include any combination of one or more global and/or regional navigation satellite systems and/or augmentation systems, and SPS signals may include SPS, SPS-like, and/or other signals associated with such one or more SPS. A position/location determination system may include cellular base stations, pseudolites, femtocells, and other wireless systems, such as WiFi. Position/location determination techniques may utilize a combination of these systems.

A user device may be a mobile station (MS) and may refer to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, data reception, and/or position-related processing occurs at the device or at the PND. Also, “mobile station” is intended to include all devices, including wireless communication devices, computers, laptops, etc. which are capable of communication with a server, such as via the Internet, WiFi, or other network, and regardless of whether satellite signal reception, data reception, and/or position-related processing occurs at the device, at a server, or at another device associated with the network. Any operable combination of the above are also considered a “mobile station.”

While, for purposes of simplicity of explanation, the disclosed methodologies are shown and described herein as a series or number of acts, it is to be understood that the processes described herein are not limited by the order of acts, as some acts may occur in different orders and/or concurrently with other acts from that shown and described herein. For example, those skilled in the art will appreciate that a methodology could alternatively be represented as a series of interrelated states or events, such as in a state diagram. Moreover, not all illustrated acts may be required to implement a methodology in accordance with the subject methodologies disclosed herein.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. It is noted that the various illustrative logics, logical blocks, modules, and circuits described in connection with the disclosed examples may be implemented or performed with a processing unit, including a general purpose processor, a digital signal processor (DSP), an application specific integrated circuit (ASIC), a field programmable gate array (FPGA), a programmable logic device (PLD), or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processing unit may also be implemented as a combination of computing devices, e.g., a combination of a DSP and a microprocessor, a plurality of microprocessors, one or more microprocessors in conjunction with a DSP core, or any other suitable configuration.

The steps or processes of a method or algorithm described in connection with the examples disclosed herein may be embodied directly in hardware, in a software and/or firmware module executed by a processing unit, or in a combination there of. A software or firmware module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processing unit, such that the processing unit can read information from, and write information to, the storage medium. In the alternative, the storage medium may be integral to the processing unit. The processing unit and the storage medium may reside in an ASIC. The ASIC may reside in a user terminal. In the alternative, the processing unit and the storage medium may reside as discrete components in a user terminal.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. Memory may refer to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc include compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The description of the disclosed examples is provided to enable any person skilled in the art to make or use the presently disclosed methods and apparatus. Various modifications to these disclosed examples may be readily apparent to those skilled in the art, and the generic principles defined herein may be applied to other examples (e.g., in an instant messaging service or any general wireless data communication applications) without departing from the spirit or scope of the present disclosure. Thus, the present disclosure is not intended to be limited to the examples shown herein, but is to be accorded the widest scope consistent with the principles and novel features disclosed herein. Furthermore, the word “exemplary” is used exclusively herein to mean “serving as an example, instance, or illustration.” Any example described herein as “exemplary” is not necessarily to be construed as preferred or advantageous over other examples.

Accordingly, while examples of a communication system providing transmitter specific information have been illustrated and described herein, it will be appreciated that various changes can be made to the examples without departing from their spirit or essential characteristics. Therefore, the present disclosures and descriptions herein are intended to be illustrative, but not limiting, of the scope of the disclosure, which is set forth in the following claims.

What is claimed is:

1. A method for communicating transmitter specific information in a broadcast communication system, the method comprising;
inserting transmitter specific information within one of a data flow in at least one transmission frame and a control channel of the at least one transmission frame, wherein the transmitter specific information includes location information about at least one transmitter;
encoding a transmitter identifier in a positioning pilot channel (PPC) within the at least one transmission frame; and
transmitting the at least one transmission frame to at least one user device.

2. The method as defined in claim 1, wherein the transmitter specific information includes the transmitter identifier, transmitter latitude, transmitter longitude, and at least one of transmitter altitude, network delay of the transmitter, and transmitter power of the transmitter corresponding to the transmitter identifier.

3. The method as defined in claim 1, wherein the transmitter specific information is configured as messaging in the data flow using markup language code.

4. The method as defined in claim 1, further comprising:
inserting assistance data within one of the data flow of at least one transmission frame and another data flow of the at least one transmission frame.

5. The method as defined in claim 4, wherein the assistance data includes at least one of geographic map data concerning a transmitter area, altitude patterns of the transmitter area, and topographic data concerning the transmitter area.

6. The method as defined in claim 4, further comprising inserting an assistance data identifier into the data flow conveying the transmitter specific information, wherein the assistance data identifier is operable to enable the user device to locate the assistance data when inserted into the another data flow.

7. The method as defined in claim 1, further comprising:
providing a data flow identification discovery mechanism via a network serving the broadcast communication system when a location of the data flow within the at least one transmission frame is not known to the user device, wherein the data flow identification is operable to enable the user device to locate the data flow within the at least one transmission frame.

8. The method as defined in claim 7, wherein the data flow identification discovery mechanism includes:
providing a DNS lookup to determine service records for a positioning service that utilizes the transmitter specific information in order to obtain a corresponding IP address and port number; and
mapping the IP address and port number to the data flow identification.

9. The method as defined in claim 1, wherein the transmitter specific information is inserted into the control channel with a transmitter information message fragmented into a plurality of Control Protocol Packets (CPPs).

10. The method as defined in claim 1, further comprising:
inserting assistance data within the control channel of the at least one transmission frame.

11. The method as defined in claim 1, further comprising:
prior to inserting the transmitter specific information within one of the data flow and the control channel of the at least one transmission frame:
provisioning the transmitter specific information from an operator to at least one network server; and
distributing the transmitter specific information from the at least one network server to a plurality of transmitters via a network.

12. The method as defined in claim 1, wherein the broadcast communication system is one of a MediaFLO system and DVB-H system.

13. An apparatus for communicating transmitter specific information in a broadcast communication system, the apparatus comprising:
at least one processing unit configured to:
insert transmitter specific information within one of a data flow in at least one transmission frame and a control channel of the at least one transmission frame, wherein the transmitter specific information includes location information about at least one transmitter;
encode a transmitter identifier in a positioning pilot channel (PPC) within the at least one transmission frame; and
transmit the at least one transmission frame to at least one user device; and
a memory coupled to the at least one processing unit.

14. The apparatus as defined in claim 13, wherein the transmitter specific information includes the transmitter identifier, transmitter latitude, transmitter longitude, and at least one of transmitter altitude, network delay of the transmitter, and transmitter power of the transmitter corresponding to the transmitter identifier.

15. The apparatus as defined in claim 13, wherein the transmitter specific information is configured as messaging in the data flow using markup language code.

16. The apparatus as defined in claim 13, wherein the at least one processing unit is further configured to:
insert assistance data within one of the data flow of at least one transmission frame and another data flow of the at least one transmission frame.

17. The apparatus as defined in claim 16, wherein the assistance data includes at least one of geographic map data concerning a transmitter area, altitude patterns of the transmitter area, and topographic data concerning the transmitter area.

18. The apparatus as defined in claim 16, wherein the at least one processing unit is further configured to:
insert an assistance data identifier into the data flow conveying the transmitter specific information, wherein the assistance data identifier is operable to enable the user device to locate the assistance data when inserted into the another data flow.

19. The apparatus as defined in claim 13, wherein the at least one processing unit is further configured to:
enable a data flow identification discovery mechanism via a network serving the broadcast communication system when a location of the data flow within the at least one transmission frame is not known to the user device, wherein the data flow identification is operable to enable the user device to locate the data flow within the at least one transmission frame.

20. The apparatus as defined in claim 19, wherein the data flow identification discovery mechanism includes:
a DNS lookup configured to determine service records for a positioning service that utilizes the transmitter specific information in order to obtain a corresponding IP address and port number; and
a mapping mechanism configured to map the IP address and port number to the data flow identification.

21. The apparatus as defined in claim 13, wherein the transmitter specific information is inserted into the control channel with a transmitter information message fragmented into a plurality of Control Protocol Packets (CPPs).

22. The apparatus as defined in claim 13, wherein the at least one processing unit is further configured to:
insert assistance data within the control channel of the at least one transmission frame.

23. The apparatus as defined in claim 13, comprising at least one further processing unit configured to:
provision the transmitter specific information from an operator to at least one network server; and
distribute the transmitter specific information from the at least one network server to a plurality of transmitters via a network prior to insertion of the transmitter specific information within one of the data flow and the control channel of the at least one transmission frame.

24. The apparatus as defined in claim 13, wherein the broadcast communication system is one of a MediaFLO system and DVB-H system.

25. An apparatus for communicating transmitter specific information in a broadcast communication system, the apparatus comprising;
means for inserting transmitter specific information within one of a data flow in at least one transmission frame and a control channel of the at least one transmission frame, wherein the transmitter specific information includes location information about at least one transmitter;
means for encoding a transmitter identifier in a positioning pilot channel (PPC) within the at least one transmission frame; and
means for transmitting the at least one transmission frame to at least one user device.

26. The apparatus as defined in claim 25, wherein the transmitter specific information includes the transmitter identifier, transmitter latitude, transmitter longitude, and at least one of transmitter altitude, network delay of the transmitter, and transmitter power of the transmitter corresponding to the transmitter identifier.

27. The apparatus as defined in claim 25, wherein the transmitter specific information is configured as messaging in the data flow using markup language code.

28. The apparatus as defined in claim 25, further comprising:
means for inserting assistance data within one of the data flow of at least one transmission frame and another data flow of the at least one transmission frame.

29. The apparatus as defined in claim 28, wherein the assistance data includes at least one of geographic map data concerning a transmitter area, altitude patterns of the transmitter area, and topographic data concerning the transmitter area.

30. The apparatus as defined in claim 28, further comprising means for inserting an assistance data identifier into the data flow conveying the transmitter specific information, wherein the assistance data identifier is operable to enable the user device to locate the assistance data when inserted into the another data flow.

31. The apparatus as defined in claim 25, further comprising:
means for providing a data flow identification discovery mechanism via a network serving the broadcast communication system when a location of the data flow within the at least one transmission frame is not known to the user device, wherein the data flow identification is operable to enable the user device to locate the data flow within the at least one transmission frame.

32. The apparatus as defined in claim 31, wherein the data flow identification discovery mechanism includes:
means for providing a DNS lookup to determine service records for a positioning service that utilizes the transmitter specific information in order to obtain a corresponding IP address and port number; and
means for mapping the IP address and port number to the data flow identification.

33. The apparatus as defined in claim 25, wherein the means for inserting transmitter specific information into the control channel includes means for inserting the transmitter specific information within a transmitter information message fragmented into a plurality of Control Protocol Packets (CPPs).

34. The apparatus as defined in claim 25, further comprising:
means for inserting assistance data within the control channel of the at least one transmission frame.

35. The apparatus as defined in claim 25, further comprising:
means for provisioning the transmitter specific information from an operator to at least one network server; and
means for distributing the transmitter specific information from the at least one network server to a plurality of transmitters via a network prior to operation of the means for inserting the transmitter specific information within one of the data flow and the control channel of the at least one transmission frame.

36. The apparatus as defined in claim 25, wherein the broadcast communication system is one of a MediaFLO system and DVB-H system.

37. A computer-readable medium encoded with instructions that, when executed by a processing unit, communicate transmitter specific information in a broadcast communication system, the instructions comprising:
code to cause a processing unit to insert transmitter specific information within one of a data flow in at least one transmission frame and a control channel of the at least one transmission frame, wherein the transmitter specific information includes location information about at least one transmitter;
code to cause a processing unit to encode a transmitter identifier in a positioning pilot channel (PPC) within the at least one transmission frame; and
code to cause a processing unit to initiate transmission of the at least one transmission frame to at least one user device.

38. The computer-readable medium as defined in claim 37, wherein the transmitter specific information includes the transmitter identifier, transmitter latitude, transmitter longitude, and at least one of transmitter altitude, network delay of the transmitter, and transmitter power of the transmitter corresponding to the transmitter identifier.

39. The computer-readable medium as defined in claim 37, wherein the transmitter specific information is configured as messaging in the data flow using markup language code.

40. The computer-readable medium as defined in claim 37, the instructions further comprising:
code to cause a processing unit to insert assistance data within one of the data flow of at least one transmission frame and another data flow of the at least one transmission frame.

41. The computer-readable medium as defined in claim 40, wherein the assistance data includes at least one of geographic map data concerning a transmitter area, altitude patterns of the transmitter area, and topographic data concerning the transmitter area.

42. The computer-readable medium as defined in claim 40, the instructions further comprising code to cause a processing unit to insert an assistance data identifier into the data flow conveying the transmitter specific information, wherein the assistance data identifier is operable to enable the user device to locate the assistance data when inserted into the another data flow.

43. The computer-readable medium as defined in claim 37, the instructions further comprising:
code to cause a processing unit to execute a data flow identification discovery mechanism via a network serving the broadcast communication system when a location of the data flow within the at least one transmission frame is not known to the user device, wherein the data flow identification is operable to enable the user device to locate the data flow within the at least one transmission frame.

44. The computer-readable medium as defined in claim 43, wherein the data flow identification discovery mechanism includes instructions, comprising:
code to cause a processing unit to provide a DNS lookup to determine service records for a positioning service that utilizes the transmitter specific information in order to obtain a corresponding IP address and port number; and
code to cause a processing unit to map the IP address and port number to the data flow identification.

45. The computer-readable medium as defined in claim 37, wherein the transmitter specific information is inserted into the control channel with a transmitter information message fragmented into a plurality of Control Protocol Packets (CPPs).

46. The computer-readable medium as defined in claim 37, the instructions further comprising:
code to cause a processing unit to insert assistance data within the control channel of the at least one transmission frame.

47. The computer-readable medium as defined in claim 37, the instructions further comprising:
code to cause a processing unit to provision the transmitter specific information from an operator to at least one network server; and
code to cause a processing unit to distribute the transmitter specific information from the at least one network server to a plurality of transmitters via a network prior insertion of the transmitter specific information within one of the data flow and the control channel of the at least one transmission frame.

48. The computer-readable medium as defined in claim 37, wherein the computer program-readable medium is used in a broadcast communication system comprising one of a MediaFLO system and DVB-H system.

49. A method for receiving transmitter specific information in a device in a broadcast communication system, the method comprising:
receiving at least one transmission frame from a transmitter, wherein the transmission frame includes transmitter specific information placed within one of a data flow in the at least one transmission frame and a control channel of the at least one transmission frame, wherein the transmitter specific information includes location information about at least one transmitter;
receiving the at least one transmission frame and at least one other of a plurality of transmission frames, each including a PPC channel having a respective encoded transmitter identifier; and
decoding the at least one transmission frame and the at least one other of the plurality of transmission frames to determine the transmitter specific information from one of the data flow and the control channel, and to determine transmitter identifiers from the respective PPC channels.

50. The method as defined in claim 49, further comprising:
calculating distances from the device to a plurality of transmitters based on signals in the respective PPC channels, the determined transmitter identifiers, and the transmitter specific information; and
determining a position of the device using the calculated distances using a predetermined triangulation technique.

51. The method as defined in claim 49, wherein the transmitter specific information includes the transmitter identifier, transmitter latitude, transmitter longitude, and at least one of transmitter altitude, network delay of the transmitter, and transmitter power of the transmitter corresponding to the transmitter identifier.

52. The method as defined in claim 49, wherein the transmitter specific information is configured as messaging in the data flow using markup language code and decoding the at least one transmission frame includes processing the markup language code to obtain the transmitter specific information.

53. The method as defined in claim 49, further comprising:
receiving assistance data within one of the data flow of at least one transmission frame and another data flow of the at least one transmission frame.

54. The method as defined in claim 53, wherein the assistance data includes at least one of geographic map data concerning a transmitter area, altitude patterns of the transmitter area, and topographic data concerning the transmitter area.

55. The method as defined in claim 53, further comprising obtaining an assistance data identifier from the data flow conveying the transmitter specific information, wherein the assistance data identifier is operable to enable the device to locate the assistance data when inserted into the another data flow.

56. The method as defined in claim 49, further comprising:
utilizing a data flow identification discovery mechanism via a network serving the broadcast communication system when a location of the data flow within the at least one transmission frame is not known to the device, wherein the data flow identification is operable to enable the device to locate the data flow within the at least one transmission frame.

57. The method as defined in claim 56, wherein the data flow identification discovery mechanism includes:
performing a DNS lookup to determine service records for a positioning service that utilizes the transmitter specific information in order to obtain a corresponding IP address and port number; and
mapping the IP address and port number to the data flow identification.

58. The method as defined in claim 49, wherein the transmitter specific information is inserted into the control channel with a transmitter information message fragmented into a plurality of Control Protocol Packets (CPPs).

59. The method as defined in claim 49, wherein the broadcast communication system is one of a MediaFLO system and DVB-H system.

60. An apparatus for receiving transmitter specific information in a device in a broadcast communication system, the apparatus comprising:
at least one processing unit configured to:
receive at least one transmission frame from a transmitter, wherein the transmission frame includes transmitter specific information placed within one of a data flow in the at least one transmission frame and a control channel of the at least one transmission frame, wherein the transmitter specific information includes location information about at least one transmitter;
receive the at least one transmission frame and at least one other of a plurality of transmission frames, each including a PPC channel having a respective encoded transmitter identifier; and
decode the at least one transmission frame and the at least one other of the plurality of transmission frames to determine the transmitter specific information from one of the data flow and the control channel, and to determine transmitter identifiers from the respective PPC channels; and
a memory coupled to the at least one processing unit.

61. The apparatus as defined in claim 60, wherein the at least one processing unit is further configured to:
calculate distances from the device to a plurality of transmitters based on signals in the respective PPC channels, the determined transmitter identifiers, and the transmitter specific information; and
determine a position of the device using the calculated distances using a predetermined triangulation technique.

62. The apparatus as defined in claim 60, wherein the transmitter specific information includes the transmitter identifier, transmitter latitude, transmitter longitude, and at least one of transmitter altitude, network delay of the transmitter, and transmitter power of the transmitter corresponding to the transmitter identifier.

63. The apparatus as defined in claim 60, wherein the transmitter specific information is configured as messaging in the data flow using markup language code and the at least one processing unit configured to decode the at least one transmission frame includes the at least one processing unit configured to process the markup language code to obtain the transmitter specific information.

64. The apparatus as defined in claim 60, wherein the at least one processing unit is further configured to:
receive assistance data within one of the data flow of at least one transmission frame and another data flow of the at least one transmission frame.

65. The apparatus as defined in claim 64, wherein the assistance data includes at least one of geographic map data concerning a transmitter area, altitude patterns of the transmitter area, and topographic data concerning the transmitter area.

66. The apparatus as defined in claim 64, wherein the at least one processing unit is further configured to obtain an assistance data identifier from the data flow conveying the transmitter specific information, wherein the assistance data identifier is operable to enable the device to locate the assistance data when inserted into the another data flow.

67. The apparatus as defined in claim 60, wherein the at least one processing unit is further configured to:
utilize a data flow identification discovery mechanism via a network serving the broadcast communication system when a location of the data flow within the at least one transmission frame is not known to the device, wherein the data flow identification is operable to enable the device to locate the data flow within the at least one transmission frame.

68. The apparatus as defined in claim 67, wherein the data flow identification discovery mechanism includes the at least one processing unit further configured to:
perform a DNS lookup to determine service records for a positioning service that utilizes the transmitter specific information in order to obtain a corresponding IP address and port number; and
map the IP address and port number to the data flow identification.

69. The apparatus as defined in claim 60, wherein the transmitter specific information is inserted into the control channel with a transmitter information message fragmented into a plurality of Control Protocol Packets (CPPs).

70. The apparatus as defined in claim 60, wherein the broadcast communication system is one of a MediaFLO system and DVB-H system.

71. An apparatus for receiving transmitter specific information in a device in a broadcast communication system, the apparatus comprising:
means for receiving at least one transmission frame from a transmitter, wherein the transmission frame includes transmitter specific information placed within one of a data flow in the at least one transmission frame and a control channel of the at least one transmission frame, wherein the transmitter specific information includes location information about at least one transmitter;
means for receiving the at least one transmission frame and at least one other of a plurality of transmission frames, each including a PPC channel having a respective encoded transmitter identifier; and
means for decoding the at least one transmission frame and the at least one other of the plurality of transmission frames to determine the transmitter specific information from one of the data flow and the control channel, and to determine transmitter identifiers from the respective PPC channels.

72. The apparatus as defined in claim 71, further comprising:
means for calculating distances from the device to a plurality of transmitters based on signals in the respective PPC channels, the determined transmitter identifiers, and the transmitter specific information; and
means for determining a position of the device using the calculated distances using a predetermined triangulation technique.

73. The apparatus as defined in claim 71, wherein the transmitter specific information includes the transmitter identifier, transmitter latitude, transmitter longitude, and at least one of transmitter altitude, network delay of the transmitter, and transmitter power of the transmitter corresponding to the transmitter identifier.

74. The apparatus as defined in claim 71, wherein the transmitter specific information is configured as messaging in the data flow using markup language code and the means for decoding the at least one transmission frame includes means for processing the markup language code to obtain the transmitter specific information.

75. The apparatus as defined in claim 71, further comprising:
means for receiving assistance data within one of the data flow of at least one transmission frame and another data flow of the at least one transmission frame.

76. The apparatus as defined in claim 75, wherein the assistance data includes at least one of geographic map data concerning a transmitter area, altitude patterns of the transmitter area, and topographic data concerning the transmitter area.

77. The apparatus as defined in claim 75, further comprising means for obtaining an assistance data identifier from the data flow conveying the transmitter specific information, wherein the assistance data identifier is operable to enable the device to locate the assistance data when inserted into the another data flow.

78. The apparatus as defined in claim 71, further comprising:
means for data flow identification discovery via a network serving the broadcast communication system when a location of the data flow within the at least one transmission frame is not known to the device, wherein the data flow identification is operable to enable the device to locate the data flow within the at least one transmission frame.

79. The apparatus as defined in claim 78, wherein the means for data flow identification discovery includes:
means for performing a DNS lookup to determine service records for a positioning service that utilizes the transmitter specific information in order to obtain a corresponding IP address and port number; and
means for mapping the IP address and port number to the data flow identification.

80. The apparatus as defined in claim 71, wherein the transmitter specific information is inserted into the control channel with a transmitter information message fragmented into a plurality of Control Protocol Packets (CPPs).

81. The apparatus as defined in claim 71, wherein the broadcast communication system is one of a MediaFLO system and DVB-H system.

82. A computer-readable medium encoded with instructions that, when executed by a processing unit, communicate transmitter specific information in a broadcast communication system, the instructions comprising:
code to cause a processing unit to receive at least one transmission frame from a transmitter, wherein the transmission frame includes transmitter specific information placed within one of a data flow in the at least one transmission frame and a control channel of the at least one transmission frame, wherein the transmitter specific information includes location information about at least one transmitter;
code to cause a processing unit to receive the at least one transmission frame and at least one other of a plurality of transmission frames, each including a PPC channel having a respective encoded transmitter identifier; and
code to cause a processing unit to decode the at least one transmission frame and the at least one other of the plurality of transmission frames to determine the transmitter specific information from one of the data flow and the control channel, and to determine transmitter identifiers from the respective PPC channels.

83. The computer-readable medium as defined in claim 82, the instructions further comprising:
code to cause a processing unit to calculate distances from a device to a plurality of transmitters based on signals in the respective PPC channels, the determined transmitter identifiers, and the transmitter specific information; and
code to cause a processing unit to determining a position of the device using the calculated distances using a predetermined triangulation technique.

84. The computer-readable medium as defined in claim 82, wherein the transmitter specific information includes the transmitter identifier, transmitter latitude, transmitter longitude, and at least one of transmitter altitude, network delay of the transmitter, and transmitter power of the transmitter corresponding to the transmitter identifier.

85. The computer-readable medium as defined in claim 82, wherein the transmitter specific information is configured as messaging in the data flow using markup language code and code to decode the at least one transmission frame includes code to process the markup language code to obtain the transmitter specific information.

86. The computer-readable medium as defined in claim 82, the instructions further comprising:
code to cause a processing unit to receive assistance data within one of the data flow of at least one transmission frame and another data flow of the at least one transmission frame.

87. The computer-readable medium as defined in claim 86, wherein the assistance data includes at least one of geographic map data concerning a transmitter area, altitude patterns of the transmitter area, and topographic data concerning the transmitter area.

88. The computer-readable medium as defined in claim 86, the instructions further comprising code to obtain an assistance data identifier from the data flow conveying the transmitter specific information, wherein the assistance data identifier is operable to enable the device to locate the assistance data when inserted into the another data flow.

89. The computer-readable medium as defined in claim 82, the instructions further comprising:
code to cause a processing unit to execute a data flow identification discovery mechanism via a network serving the broadcast communication system when a location of the data flow within the at least one transmission frame is not known to the device, wherein the data flow identification is operable to enable the device to locate the data flow within the at least one transmission frame.

90. The computer-readable medium as defined in claim 89, wherein the data flow identification discovery mechanism includes instructions, comprising:
code to cause a processing unit to perform a DNS lookup to determine service records for a positioning service that utilizes the transmitter specific information in order to obtain a corresponding IP address and port number; and
code to cause a processing unit to map the IP address and port number to the data flow identification.

91. The computer-readable medium as defined in claim 82, wherein the transmitter specific information is inserted into the control channel with a transmitter information message fragmented into a plurality of Control Protocol Packets (CPPs).

92. The computer-readable medium as defined in claim 82, wherein the computer-readable medium is used in a broadcast communication system comprising one of a MediaFLO system and DVB-H system.
